(19) United States
(12) Patent Application Publication
(10) Pub. No.: US 2012/0059645 A1
(43) Pub. Date: Mar. 8, 2012

(54) Methods and Apparatus for Teaching or Learning Vocabulary

(76) Inventor: Joshua Ethan Kim, Rancho Santa Fe, CA (US)

(21) Appl. No.: 13/225,552

(22) Filed: Sep. 6, 2011

Related U.S. Application Data
(60) Provisional application No. 61/380,697, filed on Sep. 7, 2010.

(51) Int. Cl. G06F 17/20; G06F 17/27

(52) U.S. Cl. 704/8; 704/9; 704/E11.001

(57) ABSTRACT

Provided herein are methods and apparatus for teaching or learning vocabulary comprising providing a writing instrument and one or more vocabulary words and corresponding definitions displayed on the exterior surface of the writing instrument. Also provided herein are methods and apparatus for learning terms of art or formulas comprising a writing instrument comprising one or more terms of art or formulas and the corresponding definitions or explanations displayed on the exterior surface of the writing instrument. Methods and apparatus provided herein enable users to teach or learn vocabulary in English or other languages.

### 1. CROSS-REFERENCE TO RELATED APPLICATIONS

This application claims the benefit under 35 U.S.C. §119(e) of U.S. Provisional Application No. 61/380,697, filed Sep. 7, 2010, which is incorporated herein by reference in its entirety.

### 2. FIELD OF THE INVENTION

Provided herein are methods and apparatus for teaching or learning vocabulary comprising providing a writing instrument comprising one or more vocabulary words and corresponding definitions displayed on the exterior surface of the writing instrument.

### 3. BACKGROUND

Vocabulary is an essential element of language. Vocabulary knowledge is the single most important factor in comprehension of any language. Further, research has shown that a robust vocabulary improves all areas of communication, including listening, speaking, reading, and writing.

A large body of studies spanning decades has tied vocabulary size to greater educational achievement and higher socioeconomic status. A strong vocabulary has been correlated with higher reading comprehension, test scores, and overall academic success. See Becker, Harvard Educational Review, 47:518-543 (1977); Davis, Journal of Educational Psychology, 33:365-372 (1942). Further, among the most notable benefits of a robust vocabulary is that such knowledge is heritable. According to a report issued by the Educational Testing Service, children who are raised in higher socioeconomic brackets tend to have vocabularies that are remarkably larger than those who are raised in poorer ones. See Barton et al., “Parsing the Achievement Gap II,” Educational Testing Service (2009). By the age of 3, children who are raised in a professional household know twice as many words as do children raised on welfare. See Id.

In view of the importance of a robust vocabulary, numerous methods and inventions have been developed and commercialized. Remarkably, notwithstanding the technological advancement in teaching vocabulary, flash cards have long been the most popular way to learn vocabulary. The standard method is to use 3×5 index cards with words of interest displayed on one side and the corresponding definitions displayed on the other side. However, flash cards are cumbersome and inconvenient to carry around and keep organized. Further, vocabulary flash cards are time consuming to make. Commercial vocabulary flash cards are relatively expensive.

Accordingly, there is an unmet need for new methods and apparatus that can be used to teach or learn vocabulary economically. This and other needs are met by the methods and apparatus provided herein.

### 4. SUMMARY OF THE INVENTION

In certain embodiments, provided herein are methods and apparatus for teaching or learning vocabulary comprising providing a writing instrument comprising one or more vocabulary words and corresponding definitions displayed on the exterior surface of the writing instrument.

In certain embodiments, provided herein are methods of displaying a vocabulary word and a corresponding definition on the exterior surface of a writing instrument, the method comprising (a) providing a writing instrument and (b) engraving or printing the vocabulary word and the corresponding definition on the exterior surface of the writing instrument.

In certain embodiments, provided herein are methods for providing a writing instrument comprising one or more vocabulary words and corresponding definitions displayed on the exterior surface of the writing instrument.

In certain embodiments, the writing instrument of the methods and apparatus provided herein can be a pencil, pen, marker, stylus, crayon, chalk, or brush. In a preferred embodiment, the writing instrument is a pencil or a pen.

In certain embodiments, methods and apparatus provided herein comprise displaying certain vocabulary words on the exterior surface of the writing instrument. In one embodiment, the vocabulary words can be in English. In certain embodiments, the vocabulary words can be in another language. In certain embodiments, the vocabulary words are not in another language.

In certain embodiments, methods and apparatus provided herein comprise displaying on the writing instrument certain vocabulary words selected from a list of commonly tested words in standardized tests. In some embodiments, the vocabulary words can be selected from a list of commonly tested words in Scholastic Aptitude Test (SAT®), Preliminary SATO/National Merit Scholarship Qualifying Test (PSAT/NMSQT®), Graduate Record Examination (GRE®), American College Testing (ACT®), College Level Examination Program (CLEP®), Test of English as a Foreign Language (TOEFL®), Test of English for International Communication (TOEIC®), Medical College Admission Test (MCAT®), Law School Admission Test (LSAT®), Graduate Management Admission Test (GMAT®), Veterinary College Admission Test (VCAT®), PRAXIS®, Pharmacy College Admission Test (PCAT®), Allied Health Professions Admission Test (AHPAT®), Dental Admission Test (DAT®), Optometry Admission Test (OAT®), Miller Analogies Test (MAT®), General Education Development (GED®), or any of the equivalent tests outside the United States.

In certain embodiments, methods and apparatus provided herein comprise displaying on the writing instrument certain vocabulary words selected from a certain collection or set of vocabulary words. In some embodiments, the collection of vocabulary words comprises a set of words required for sufficient academic aptitude in a specific grade level or age. In some embodiments, a set of vocabulary words comprise a collection of words required for sufficient academic aptitude in preschool, kindergarten, first grade, second grade, third grade, fourth grade, fifth grade, sixth grade, seventh grade, eighth grade, ninth grade, tenth grade, eleventh grade, twelveth grade, college, or graduate school. In some embodiments, a set of vocabulary words comprise a collection of words required for sufficient academic aptitude or proficiency at elementary school level, middle school level, or high school level. In some embodiments, a set of vocabulary words comprise a collection of words required for sufficient academic aptitude or proficiency at age 1, 2, 3, 4, 5, 6, 7, 8, 9, 10, 11, 12, 13, 14, 15, 16, 17, 18, 19, 20, 21, 22, or in the 20's, in the 30's, in the 40's, in the 50's, in the 60's, or in the 70's.

In certain embodiments, provided herein are methods and apparatus for teaching or learning terms of art or formulas comprising providing a writing instrument comprising one or more terms of art or formulas and corresponding definitions displayed on the exterior surface of the writing instrument. In certain embodiments, the terms of art or formulas are those used in fields or subjects including, but not limited to, physics, mathematics, statistics, electrical engineering, mechanical engineering, chemical engineering, computer science, metallurgy, thermodynamics, hydrology, chemistry, biology, biochemistry, immunology, microbiology, virology, oncology, urology, toxicology, radiology, pathology, pharmacology, optometry, opthalmology, physiology, psychiatry, psychology, sociology, dentistry, botany, ecology, zoology, endocrinology, epidemiology, anthropology, archaeology, paleontology, linguistics, astronomy, meteorology, oceanography, geology, economics, law, and theology.

In certain embodiments, the terms of art or formulas can be in any language, characters, units, numbers, or symbols used in fields or subjects, including, but not limited to, mathematics, physics, chemistry, or biology.

In certain embodiments, the corresponding definition is one or more words, phrases, or sentences that define or explain the vocabulary word, term of art, or formula. In one embodiment, the corresponding definition is in English. In one embodiment, the corresponding definition is in the same language as the vocabulary word. In one embodiment, the corresponding definition is in a different language than that of the vocabulary word. In one embodiment, the corresponding definition is in English or another language.

In one embodiment, the corresponding definition is a synonym. In one embodiment, the corresponding definition is provided as an antonym. In one embodiment, the corresponding definition is a description of the vocabulary word. In one embodiment, the corresponding definition is a translation of the vocabulary word in another language. In one embodiment, the corresponding definition is an explanation of the vocabulary word, in non-technical language or terms of art.

In certain embodiments, a plurality of vocabulary words, terms of art, or formulas are displayed on the exterior surface of the writing instrument. In some embodiments, a plurality of vocabulary words, terms of art, or formulas are spatially displayed and arranged on the exterior surface of the writing instrument according to the degree of difficulty in comprehension or usage. In some embodiments, easier vocabulary words, terms of art, or formulas are displayed toward or near the writing tip of the writing instrument, while more difficult vocabulary words, terms of art, or formulas are displayed toward or near the opposite end of the writing tip. In one embodiment, more difficult vocabulary words, terms of art, or formulas are displayed toward or near the writing tip of the writing instrument, while easier vocabulary words, terms of art, or formulas are displayed toward or near the opposite end of the writing tip.

In certain embodiments, a plurality of vocabulary words, terms of art, or formulas are displayed on more than one side of the exterior surface of the writing instrument. In one embodiment, a plurality of vocabulary words, terms of art, or formulas are displayed on one, two, three, four, five, six, seven, or eight sides of a round or tubular writing instrument.

In certain embodiments, provided herein are methods and apparatus for displaying one or more phrases or sentences on a writing instrument. In some embodiments, the phrases or sentences can be quotes, poetry, mottos, slogans, maxims, rules, codes, axioms, principles, theories, messages, or proverbs. In some embodiments, the phrases or sentences can be jokes or parodies. In some embodiments, the phrases or sentences can be computer codes.

In certain embodiments, provided herein are methods and apparatus for displaying one or more logos. In certain embodiments, provided herein are methods and apparatus for displaying one or more graphics, icons, pictures, or photos.

In certain embodiments, the methods provided herein comprise providing any of the apparatus as described herein.

### 5. BRIEF DESCRIPTION OF THE DRAWINGS

FIG. 1 presents an embodiment of an apparatus provided herein. The apparatus comprises a writing instrument 100, and vocabulary words 140 and corresponding definitions 150 displayed on the exterior surface 110 of the writing instrument. Vocabulary words and corresponding definitions can be spatially arranged according to the difficulty of comprehension or usage. Easier vocabulary words can be displayed toward or near the writing tip 120 of the writing instrument. More difficult vocabulary words can be displayed toward or near the opposite end of the writing tip 130.

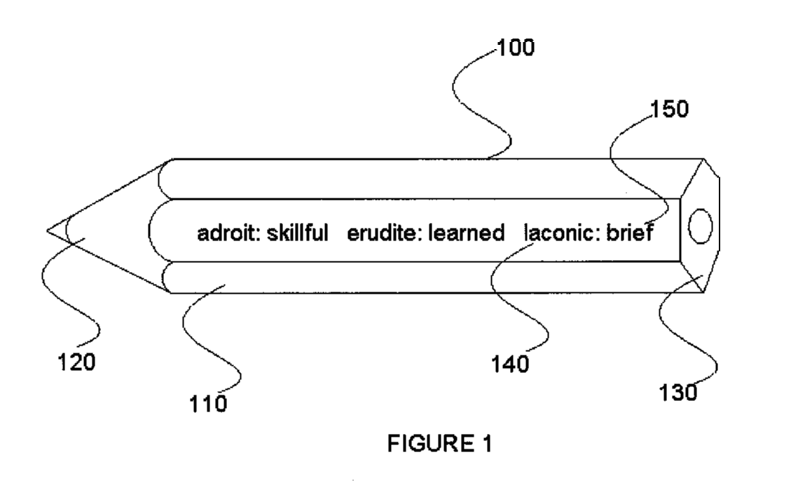

FIG. 2 presents an embodiment of an apparatus provided herein. The apparatus can comprise foreign language and corresponding definitions in English or any other language.

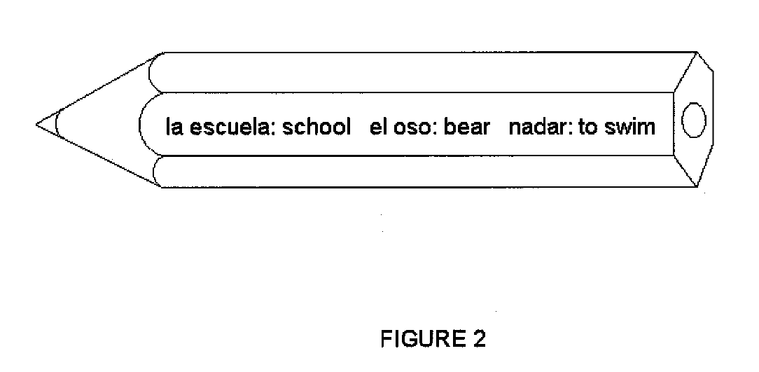

FIG. 3 presents an embodiment of an apparatus provided herein. The apparatus can comprise terms of art or formulas and corresponding definitions or descriptions in English or any other language.

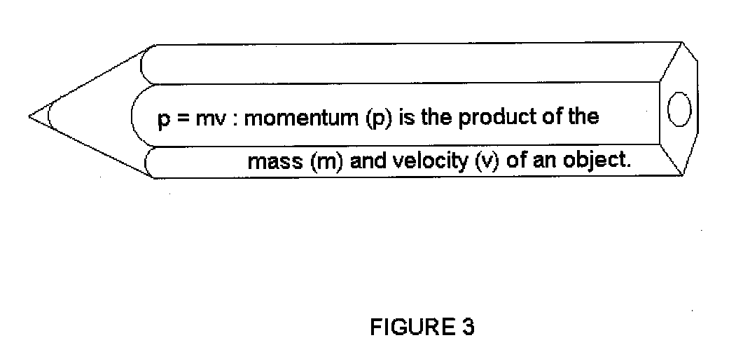

### 6. DETAILED DESCRIPTION OF THE INVENTION

Provided herein are methods and apparatus for teaching or learning vocabulary comprising providing a writing instrument comprising one or more vocabulary words and corresponding definitions displayed on the exterior surface of the writing instrument. The methods and apparatus described herein provide an economical and convenient way to teach or learn vocabulary. Writing instruments, such as pencils and pens, are compact and portable. Writing instruments are easily carried on the person. Further, writing instruments are pervasive and integrated in most work and school environment. As such, methods and apparatus described herein provide an advantageous way to teach or learn vocabulary in any place, at any time.

In certain embodiments, provided herein are methods of displaying a vocabulary word and a corresponding definition on the exterior surface of a writing instrument, the method comprising (a) providing a writing instrument and (b) engraving or printing the vocabulary word and the corresponding definition on the exterior surface of the writing instrument. In some embodiments, the vocabulary word can be engraved or printed on the writing instrument using any method known in the art. In some embodiments, the fonts of the displayed vocabulary can be in any commercially available fonts and colors.

In certain embodiments, provided herein are methods for providing a writing instrument comprising one or more vocabulary words and corresponding definitions displayed on the exterior surface of the writing instrument.

Unless defined otherwise, all terms used herein have the meaning commonly understood by a person skilled in the art. As used herein, the following terms have the meanings ascribed to them unless specified otherwise.

It must also be noted that as used herein and in the appended claims, the singular forms “a,” “an,” and “the” include plural references unless the context clearly dictates otherwise.

“Vocabulary,” as used herein, unless otherwise indicated, refers to a list or collection of words or phrases employed by a language, group, individual, or work. A “vocabulary word,” as used herein, unless otherwise indicated, refers to a word, phrase, or other units employed by a language, group, individual, or work. “Vocabulary,” as used herein, does not include terms of art or formulas in a field of knowledge or subject.

“Definition,” as used herein, unless otherwise indicated, refers to a word, a phrase, or a sentence that is commonly used to explain or provide meaning of a vocabulary word.

A “term of art,” as used herein, unless otherwise indicated, refers to a word, phrase, or other units employed in a field of knowledge or subject.

A “formula,” as used herein, unless otherwise indicated, refers to a general fact, rule, principle, or symbolic expression in a field of knowledge or subject.

In certain embodiments, the writing instrument can be a pencil, pen, marker, stylus, crayon, chalk, or brush. In a preferred embodiment, the writing instrument is a pencil or a pen. In certain embodiments, the pencil can be a graphite pencil, charcoal pencil, carbon pencil, colored pencil, grease pencil, or watercolor pencil. In certain embodiments, the pencil can be a wood pencil, plastic pencil, or stackable pencil. In certain embodiments, the pencil can be a #1 pencil (B), #2 pencil (HB), #2% pencil (F), #3 pencil (H), or #4 pencil (2H). In certain embodiments, the pencil can be a mechanical pencil, carpenter's pencil, copying pencil, erasable color pencil, non-reproducing pencil, stenographer's pencil, or golf pencil. In certain embodiments, the pencil can be a triangular pencil, hexagonal pencil, round pencil, or bendable pencil. In certain embodiments, the pen can be a ballpoint pen, rollerball pen, fountain pen, or felt-tip pen.

In certain embodiments, the marker can be a permanent marker, highlighter, erasable marker, security marker, paint marker, or election marker. In certain embodiments, the stylus can be a stylus used in connection with a personal digital assistant (FDA), graphics tablet, smart phone, tablet personal computer (PC), or ultra-mobile PC.

In certain embodiments, any vocabulary words or terms can be displayed on the exterior surface of the writing instrument. In one embodiment, the vocabulary words can be in English. In certain embodiments, the vocabulary words can be in Greek or Latin. In certain embodiments, the vocabulary words can be in Spanish, French, Italian, German, Dutch, Portuguese, Swedish, Norwegian, Russian, Polish, Romanian, Czech, Belarusian, Hungarian, Serbo-Croatian, Ukranian, Uzebek, Georgian, Slovak, Scandanavian, Danish, Finnish, Hebrew, Yiddish, Afrikaans, Mandarin, Cantonese, Korean, Japanese, Vietnamese, Thai, Indonesian, Tibetan, Hindi, Punjabi, Arabic, Bengali, Tamil, Turkish, Javanese, Wu, Telugu, Marathi, Tagalog, Gujarati, Min, Maithili, Malay, Bhojpuri, Xiang, Malayam, Kannada, Sunda, Burmese, Oriya, Persian, Berber, Hakka, Hausa, Azerbaijani, Gan, Yoruba, Sindhi, Pashto, Igbo, Napali, Saraiki, Cebuano, Assamese, Amharic, Malagasy, Zhuang, Madurese, Sinhalese, Shona, Oromo, Fula, Somali, Zulu, Swahili, Khmer, Armenian, Albanian, Mongolian, Kazakh, or Kurdish.

In certain embodiments, the vocabulary words can be selected from a list of commonly tested words in standardized tests. In some embodiments, the vocabulary words can be selected from a list of commonly tested words in Scholastic Aptitude Test (SAT®), Preliminary SAT®/National Merit Scholarship Qualifying Test (PSAT/NMSQT®), Graduate Record Examination (GRE®), American College Testing (ACT®), College Level Examination Program (CLEP®), Test of English as a Foreign Language (TOEFL®), Test of English for International Communication (TOEIC®), Medical College Admission Test (MCAT®), Law School Admission Test (LSAT®), Graduate Management Admission Test (GMAT®), Veterinary College Admission Test (VCAT®), PRAXIS®, Pharmacy College Admission Test (PCAT®), Allied Health Professions Admission Test (AHPAT®), Dental Admission Test (DAT®), Optometry Admission Test (DAT®), Miller Analogies Test (MAT®), General Education Development (GED®), or any of the equivalent tests outside the United States.

In certain embodiments, provided herein are methods and apparatus for teaching or learning terms of art or formulas comprising a writing instrument comprising one or more terms of art or formulas and corresponding definitions displayed on the exterior surface of the writing instrument. In certain embodiments, the terms of art or formulas are those used in fields or subjects including, but not limited to, physics, mathematics, statistics, electrical engineering, mechanical engineering, chemical engineering, computer science, metallurgy, thermodynamics, hydrology, chemistry, biology, biochemistry, immunology, microbiology, virology, oncology, urology, toxicology, radiology, pathology, pharmacology, optometry, opthalmology, physiology, psychiatry, psychology, sociology, dentistry, botany, ecology, zoology, endocrinology, epidemiology, anthropology, archaeology, paleontology, linguistics, astronomy, meteorology, oceanography, geology, economics, law, and theology.

In certain embodiments, the terms of art or formulas can be in any language, characters, units, numbers, or symbols used in fields or subjects, including, but not limited to, mathematics, physics, chemistry, or biology.

In certain embodiments, the corresponding definition is one or more words, phrases, or sentences that define or explain the vocabulary word, term of art, or formula. In one embodiment, the corresponding definition is in English. In one embodiment, the corresponding definition is in the same language as the vocabulary word. In one embodiment, the corresponding definition is in a different language than that of the vocabulary word. In one embodiment, the corresponding definition is in English, Greek, Latin, Spanish, French, Italian, German, Dutch, Portuguese, Swedish, Norwegian, Russian, Polish, Romanian, Czech, Belarusian, Hungarian, Serbo-Croatian, Ukranian, Uzebek, Georgian, Slovak, Scandanavian, Danish, Finnish, Hebrew, Yiddish, Afrikaans, Mandarin, Cantonese, Korean, Japanese, Vietnamese, Thai, Indonesian, Tibetan, Hindi, Punjabi, Arabic, Bengali, Tamil, Turkish, Javanese, Wu, Telugu, Marathi, Tagalog, Gujarati, Min, Maithili, Malay, Bhojpuri, Xiang, Malayam, Kannada, Sunda, Burmese, Oriya, Persian, Berber, Hakka, Hausa, Azerbaijani, Gan, Yoruba, Sindhi, Pashto, Igbo, Napali, Saraiki, Cebuano, Assamese, Amharic, Malagasy, Zhuang, Madurese, Sinhalese, Shona, Oromo, Fula, Somali, Zulu, Swahili, Khmer, Armenian, Albanian, Mongolian, Kazakh, or Kurdish.

In one embodiment, the corresponding definition is a synonym. In one embodiment, the corresponding definition is provided as an antonym. In one embodiment, the corresponding definition is a description of the vocabulary word. In one embodiment, the corresponding definition is a translation of the vocabulary word in another language. In one embodiment, the corresponding definition is an explanation of the vocabulary word, in non-technical language or terms of art. In some embodiments, definitions provided herein can be determined from any dictionary, thesaurus, encyclopedia, textbook, technical journals or manual, treatise, references, or any online editions thereof.

In certain embodiments, any of the vocabulary words, terms of art, formulas, and definitions provided herein can be in any commercially available font types, sizes, and colors, or a combination thereof.

In certain embodiments, a plurality of vocabulary words, terms of art, or formulas are displayed on the exterior surface of the writing instrument. In some embodiments, a plurality of vocabulary words, terms of art, or formulas are spatially displayed and arranged on the exterior surface of the writing instrument according to the degree of difficulty in comprehension or usage. In some embodiments, easier vocabulary words, terms of art, or formulas are displayed toward or near the writing tip of the writing instrument, while more difficult vocabulary words, terms of art, or formulas are displayed toward or near the opposite end of the writing tip. Such embodiments allow more time for the users to teach or learn more difficult words or terms before the writing instrument, such as a pencil, is sharpened and reduced in size. In one embodiment, more difficult vocabulary words, terms of art, or formulas are displayed toward or near the writing tip of the writing instrument, while easier vocabulary words, terms of art, or formulas are displayed toward or near the opposite end of the writing tip. In one embodiment, vocabulary words, terms of art, or formulas of varying difficulties are displayed randomly throughout the writing instrument.

In certain embodiments, a plurality of vocabulary words, terms of art, or formulas are displayed on more than one side of the exterior surface of the writing instrument. In one embodiment, a plurality of vocabulary words, terms of art, or formulas are displayed on one, two, or three sides of a triangular writing instrument. In one embodiment, a plurality of vocabulary words, terms of art, or formulas are displayed on one, two, three, or four sides of a quadranular writing instrument. In one embodiment, a plurality of vocabulary words, terms of art, or formulas are displayed on one, two, three, four, five, or six sides of a hexagonal writing instrument. In one embodiment, a plurality of vocabulary words, terms of art, or formulas are displayed on one, two, three, four, five, six, seven, or eight sides of a round or tubular writing instrument.

In certain embodiments, methods and apparatus provided herein can comprise a writing instrument comprising a set of vocabulary words, terms of art, or formulas in any combination. In some embodiments, the set of vocabulary words, terms of art, or formulas can be arranged alphabetically, by a specific concept, or by a logical group or family of words, terms, or formulas. In one embodiment, the set of vocabulary words, terms of art, or formulas can be arranged randomly.

In certain embodiments, methods provided herein comprise a plurality of apparatus comprising a set of vocabulary words, terms of art, or formulas or in any combination thereof. In some embodiments, a set of vocabulary words comprise a collection of words tested in standardized tests, such as Scholastic Aptitude Test (SAT®), Preliminary SAT®/National Merit Scholarship Qualifying Test (PSAT/NMSQT®), Graduate Record Examination (GRE®), American College Testing (ACT®), College Level Examination Program (CLEP®), Test of English as a Foreign Language (TOEFL®), Test of English for International Communication (TOEIC®), Medical College Admission Test (MCAT®), Law School Admission Test (LSAT®), Graduate Management Admission Test (GMAT®), Veterinary College Admission Test (VCAT®), PRAXIS®, Pharmacy College Admission Test (PCAT®), Allied Health Professions Admission Test (AHPAT®), Dental Admission Test (DAT®), Optometry Admission Test (OAT®), Miller Analogies Test (MAT®), General Education Development (GED®), or any of the equivalent tests outside the United States. Such collections of words can be compiled from past exams, obtained from the companies administering the standardized tests (e.g., Educational Testing Service), or obtained from any commercially available sources.

In certain embodiments, methods provided herein comprise providing a writing instrument comprising a certain collection or set of vocabulary words. In some embodiments, the collection of vocabulary words comprises a set of words required for sufficient academic aptitude in a specific grade level or age. In some embodiments, a set of vocabulary words comprise a collection of words required for sufficient academic aptitude in preschool, kindergarten, first grade, second grade, third grade, fourth grade, fifth grade, sixth grade, seventh grade, eighth grade, ninth grade, tenth grade, eleventh grade, twelveth grade, college, or graduate school. In some embodiments, a set of vocabulary words comprise a collection of words required for sufficient academic aptitude or proficiency at age 1, 2, 3, 4, 5, 6, 7, 8, 9, 10, 11, 12, 13, 14, 15, 16, 17, 18, 19, 20, 21, 22, or in the 20's, in the 30's, in the 40's, in the 50's, in the 60's, or in the 70's. Such collections of words can be compiled from textbooks, vocabulary books, academic journals, standardized tests, teachers, or professors, or obtained from any commercially available sources.

In certain embodiments, a set of terms of art or formulas comprise a collection of terms of art or formulas required for sufficient academic aptitude or proficiency in a specific field of knowledge or subject, such as physics, mathematics, statistics, electrical engineering, mechanical engineering, chemical engineering, computer science, metallurgy, thermodynamics, hydrology, chemistry, biology, biochemistry, immunology, microbiology, virology, oncology, urology, toxicology, radiology, pathology, pharmacology, optometry, opthalmology, physiology, psychiatry, psychology, sociology, dentistry, botany, ecology, zoology, endocrinology, epidemiology, anthropology, archaeology, paleontology, linguistics, astronomy, meteorology, oceanography, geology, economics, law, and theology. In some embodiments, a set of terms of art or formulas comprise a collection of terms of art or formulas required for sufficient academic aptitude or proficiency in a specific concept within a field of knowledge or subject. Such collections of words can be compiled from textbooks, standardized tests, technical journals or manuals, treatises, references, industry professionals, teachers, or professors, or obtained from any commercially available sources.

In certain embodiments, provided herein are methods and apparatus for displaying one or more phrases or sentences on a writing instrument. In some embodiments, the phrases or sentences can be quotes, poetry, mottos, slogans, maxims, rules, codes, axioms, principles, theories, messages, or proverbs. In some embodiments, the phrases or sentences can be jokes or parodies. In some embodiments, the phrases or sentences can be computer codes.

In certain embodiments, provided herein are methods and apparatus for displaying one or more logos. In certain embodiments, provided herein are methods and apparatus for displaying one or more graphics, icons, pictures, or photos.

In certain embodiments, the methods provided herein comprise providing any of the apparatus as described herein.

Although specific embodiments are provided herein, the foregoing description is intended to illustrate and not limit the scope of the embodiments. Other aspects, advantages, and modifications within the scope of the embodiments will be apparent to those skilled in the art.

What is claimed is:

1. A method of teaching or learning vocabulary comprising:
providing a writing instrument comprising a vocabulary word and a corresponding definition displayed on the exterior surface of the writing instrument.

2. The method of claim 1, wherein the writing instrument is a pencil, pen, marker, stylus, crayon, chalk, or brush.

3. The method of claim 1, wherein the vocabulary word is an English word.

4. The method of claim 1, wherein the vocabulary word is selected from a list of commonly tested words in Scholastic Aptitude Test (SAT®), Preliminary SAT®/National Merit Scholarship Qualifying Test (PSAT/NMSQT®), Graduate Record Examination (GRE®), American College Testing (ACT®), College Level Examination Program (CLEP®), Test of English as a Foreign Language (TOEFL®), Test of English for International Communication (TOEIC®), Medical College Admission Test (MCAT®), Law School Admission Test (LSAT®), Graduate Management Admission Test (GMAT®), Veterinary College Admission Test (VCAT®), PRAXIS®, Pharmacy College Admission Test (PCAT®), Allied Health Professions Admission Test (AHPAT®), Dental Admission Test (DAT®), Optometry Admission Test (OAT®), Miller Analogies Test (MAT®), General Education Development (GED®), or any of the equivalent tests outside the United States.

5. The method of claim 1, wherein the vocabulary word is selected from a list of commonly tested words in Scholastic Aptitude Test (SAT®).

6. The method of claim 1, wherein the vocabulary word is selected from a list of commonly tested words in American College Testing (ACT®).

7. The method of claim 1, wherein the vocabulary word is selected from a list of commonly tested words in Graduate Record Examination (GRE®).

8. The method of claim 1, wherein the vocabulary word is selected from a list of commonly tested words in Medical College Admission Test (MCAT®).

9. The method of claim 1, wherein the vocabulary word is selected from a list of commonly tested words in Law School Admission Test (LSAT®).

10. The method of claim 1, wherein the vocabulary word is selected from a list of commonly tested words in Graduate Management Admission Test (GMAT®).

11. The method of claim 1, wherein the vocabulary word is selected from a collection of words required for sufficient academic aptitude in a specific grade level or age.

12. The method of claim 11, wherein the vocabulary word is selected from a collection of words required for sufficient academic aptitude in preschool, kindergarten, first grade, second grade, third grade, fourth grade, fifth grade, sixth grade, seventh grade, eighth grade, ninth grade, tenth grade, eleventh grade, twelveth grade, elementary school, middle school, high school, college, or graduate school.

13. The method of claim 1, wherein the vocabulary word is a Spanish, French, Italian, German, Greek, Latin, Hebrew, Dutch, Portuguese, Swedish, Norwegian, Russian, Polish, Romanian, Czech, Belarusian, Hungarian, Serbo-Croatian, Ukranian, Uzebek, Georgian, Slovak, Scandanavian, Danish, Finnish, Yiddish, Afrikaans, Mandarin, Cantonese, Korean, Japanese, Vietnamese, Thai, Indonesian, Tibetan, Hindi, Punjabi, Arabic, Bengali, Tamil, Turkish, Javanese, Wu, Telugu, Marathi, Tagalog, Gujarati, Min, Maithili, Malay, Bhojpuri, Xiang, Malayam, Kannada, Sunda, Burmese, Oriya, Persian, Berber, Hakka, Hausa, Azerbaijani, Gan, Yoruba, Sindhi, Pashto, Igbo, Napali, Saraiki, Cebuano, Assamese, Amharic, Malagasy, Zhuang, Madurese, Sinhalese, Shona, Oromo, Fula, Somali, Zulu, Swahili, Khmer, Armenian, Albanian, Mongolian, Kazakh, or Kurdish word.

14. The method of claim 1, wherein the corresponding definition is in English.

15. The method of claim 1, wherein the corresponding definition is in the same language as the vocabulary word.

16. The method of claim 1, wherein the corresponding definition is in a different language than that of the vocabulary word.

17. A method for teaching or learning terms of art or formulas comprising:
providing a writing instrument comprising a term of art or formula and a corresponding definition displayed on the exterior surface of the writing instrument.

18. The method of claim 11, wherein the term of art or formula is that of physics, mathematics, chemistry, biology, statistics, electrical engineering, mechanical engineering, chemical engineering, computer science, metallurgy, thermodynamics, hydrology, biochemistry, immunology, microbiology, virology, oncology, urology, toxicology, radiology, pathology, pharmacology, optometry, opthalmology, physiology, psychiatry, psychology, sociology, dentistry, botany, ecology, zoology, endocrinology, epidemiology, anthropology, archaeology, paleontology, linguistics, astronomy, meteorology, oceanography, geology, economics, law, or theology.

19. The method of claim 11, wherein the corresponding definition is in English, Spanish, French, Italian, German, Greek, Latin, Hebrew, Dutch, Portuguese, Swedish, Norwegian, Russian, Polish, Romanian, Czech, Belarusian, Hungarian, Serbo-Croatian, Ukranian, Uzebek, Georgian, Slovak, Scandanavian, Danish, Finnish, Yiddish, Afrikaans, Mandarin, Cantonese, Korean, Japanese, Vietnamese, Thai, Indonesian, Tibetan, Hindi, Punjabi, Arabic, Bengali, Tamil, Turkish, Javanese, Wu, Telugu, Marathi, Tagalog, Gujarati, Min, Maithili, Malay, Bhojpuri, Xiang, Malayam, Kannada, Sunda, Burmese, Oriya, Persian, Berber, Hakka, Hausa, Azerbaijani, Gan, Yoruba, Sindhi, Pashto, Igbo, Napali, Saraiki, Cebuano, Assamese, Amharic, Malagasy, Zhuang, Madurese, Sinhalese, Shona, Oromo, Fula, Somali, Zulu, Swahili, Khmer, Armenian, Albanian, Mongolian, Kazakh, or Kurdish.

20. A method of displaying a vocabulary word and a corresponding definition on the exterior surface of a writing instrument, the method comprising
providing a writing instrument and
engraving or printing the vocabulary word and the corresponding definition on the exterior surface of the writing instrument.
